(19) United States
(12) Patent Application Publication
(10) Pub. No.: US 2014/0196238 A1
(43) Pub. Date: Jul. 17, 2014

(54) Snow Removal Apparatus and System

(71) Applicants: Wilmar Valverde, Seymour, CT (US); Bart Hogestyn, Oxford, CT (US)

(72) Inventors: Wilmar Valverde, Seymour, CT (US); Bart Hogestyn, Oxford, CT (US)

(73) Assignee: SNOW BE GONE, INC., Milford, CT (US)

(21) Appl. No.: 14/153,595

(22) Filed: Jan. 13, 2014

Related U.S. Application Data
(60) Provisional application No. 61/751,998, filed on Jan. 14, 2013.

(51) Int. Cl. B60S 1/66

(52) U.S. Cl. CPC B60S 1/66
USPC 15/246

(57) ABSTRACT

A low profile snow removal system comprising: a motor-gearbox; a first blade drive shaft in operational communication with the motor-gearbox; a first front sprocket in fixed communication with the first blade drive shaft; a first track housing the first front sprocket at the front end of the first track, the first track comprising a first blade holder member located on a portion of the first track that is generally oriented in a downward position at generally 90° with the respect to the remainder of the first track and is also located at the front end of the first track; a first rear sprocket located in the first track on the rear end of the track; a first transmission means in rotatable communication with the first front sprocket and the first rear sprocket, and configured to generally rotate in either direction along the length and downward oriented portion of the first track; a second blade drive shaft in operational communication with the motor-gearbox; a second front sprocket in fixed communication with the second blade drive shaft; a second track housing the second front sprocket at the front end of the second track, the second track comprising a second blade holder member located on a portion of the second track that is generally oriented in a downward position at generally 90° with the respect to the remainder of the second track and is also located at the front end of the second track; a second rear sprocket located in the second track on the rear end of the track; a second transmission means in rotatable communication with the second front sprocket and the second rear sprocket, and configured to generally rotate in either direction along the length and downward oriented portion of the second track; a snow removal blade attached via attachment members to the first and second transmission means and configured to be able to travel along the length and downward oriented portion of the first and second tracks. A low profile snow removal apparatus comprising: a motor-gearbox; a first blade drive shaft configured to be in operational communication with the motor-gearbox; a first front sprocket configured to be in fixed communication with the first blade drive shaft; a first track housing the first front sprocket at the front end of the first track, the first track comprising a first blade holder member located on a portion of the first track that is generally oriented in a downward position at generally 90° with the respect to the remainder of the first track and is also located at the front end of the first track; a first rear sprocket located in the first track on the rear end of the track; a first transmission means configured to in rotatable communication with the first front sprocket and the first rear sprocket, and configured to generally rotate in either direction along the length and downward oriented portion of the first track; a second blade drive shaft configured to be in operational communication with the motor-gearbox; a second front sprocket configured to be in fixed communication with the second blade drive shaft; a second track housing the second front sprocket at the front end of the second track, the second track comprising a second blade holder member located on a portion of the second track that is generally oriented in a downward position at generally 90° with the respect to the remainder of the second track and is also located at the front end of the second track; a second rear sprocket located in the second track on the rear end of the track; a second transmission means configured to be in rotatable communication with the second front sprocket and the second rear sprocket, and configured to generally rotate in either direction along the length and downward oriented portion of the second track; a snow removal blade configured to be attached via attachment members to the first and second transmission means and configured to be able to travel along the length and downward oriented portion of the first and second tracks.

### CROSS-REFERENCES

This patent application claims the benefit of provisional patent application No. 61/751,998, by Wilmar Valverde and Burt Hogestyn, entitled “Snow Removal Apparatus and System”, filed on Jan. 14, 2013, and which provisional application is fully incorporated by reference herein.

### TECHNICAL FIELD

An apparatus and system to remove snow accumulations from the rooftops of large commercial trailers, buses, and other vehicles.

### BACKGROUND

Semi-trailer trucks typically include a tractor having a cab where the driver sits. The tractor pulls a trailer that carries freight. Box trailers may have an about a 53-foot long flat rooftop that resides about 13.5 feet above the ground. In the colder climates, snow and ice may accumulate on these large, flat surfaces while they are parked.

Accumulations falling from box trailers and other vehicles having large, flat rooftops pose a significant safety risk to other drivers on the road. For example, the accumulated snow and ice may be blown off or fly off the rooftop and onto unsuspecting vehicles sharing the roadway. Unsuspecting motorists may be temporarily blinded by this accumulated snow or receive serious vehicular damage from large chunks of ice leaving the rooftops of these big rigs.

Vehicle rooftop snow accumulations present other problems. For example, big rig drivers may be cited by the police if they carry accumulated snow on their rooftops. In addition, part of the insurance costs carried by many big rig drivers goes towards insuring against damage caused by rooftop accumulations. In addition, heavy ice and snow residing on the trailer rooftop affect the handling, aerodynamics, and highway fuel economy of these large vehicles.

Drivers sometimes climb on top of their trailer to manually clear off ice and snow accumulations with a broom or shovel. This is a near-impossible task and puts the driver at serious risk of slipping and falling from the trailer rooftop.

One known device significantly raises the profile of the vehicle, such that wind resistance, lowered gas mileage, and clearance over the vehicle all become detrimental issues.

Thus there is a need for a snow removal apparatus and system that overcomes the above listed and other disadvantages.

### SUMMARY OF THE INVENTION

The disclosed invention relates to a low profile snow removal system comprising: a motor-gearbox; a first blade drive shaft in operational communication with the motor-gearbox; a first front sprocket in fixed communication with the first blade drive shaft; a first track housing the first front sprocket at the front end of the first track, the first track comprising a first blade holder member located on a portion of the first track that is generally oriented in a downward position at generally 90° with the respect to the remainder of the first track and is also located at the front end of the first track; a first rear sprocket located in the first track on the rear end of the track; a first transmission means in rotatable communication with the first front sprocket and the first rear sprocket, and configured to generally rotate in either direction along the length and downward oriented portion of the first track; a second blade drive shaft in operational communication with the motor-gearbox; a second front sprocket in fixed communication with the second blade drive shaft; a second track housing the second front sprocket at the front end of the second track, the second track comprising a second blade holder member located on a portion of the second track that is generally oriented in a downward position at generally 90° with the respect to the remainder of the second track and is also located at the front end of the second track; a second rear sprocket located in the second track on the rear end of the track; a second transmission means in rotatable communication with the second front sprocket and the second rear sprocket, and configured to generally rotate in either direction along the length and downward oriented portion of the second track; a snow removal blade attached via attachment members to the first and second transmission means and configured to be able to travel along the length and downward oriented portion of the first and second tracks.

The invention also relates to a low profile snow removal apparatus comprising: a motor-gearbox; a first blade drive shaft configured to be in operational communication with the motor-gearbox; a first front sprocket configured to be in fixed communication with the first blade drive shaft; a first track housing the first front sprocket at the front end of the first track, the first track comprising a first blade holder member located on a portion of the first track that is generally oriented in a downward position at generally 90° with the respect to the remainder of the first track and is also located at the front end of the first track; a first rear sprocket located in the first track on the rear end of the track; a first transmission means configured to in rotatable communication with the first front sprocket and the first rear sprocket, and configured to generally rotate in either direction along the length and downward oriented portion of the first track; a second blade drive shaft configured to be in operational communication with the motor-gearbox; a second front sprocket configured to be in fixed communication with the second blade drive shaft; a second track housing the second front sprocket at the front end of the second track, the second track comprising a second blade holder member located on a portion of the second track that is generally oriented in a downward position at generally 90° with the respect to the remainder of the second track and is also located at the front end of the second track; a second rear sprocket located in the second track on the rear end of the track; a second transmission means configured to be in rotatable communication with the second front sprocket and the second rear sprocket, and configured to generally rotate in either direction along the length and downward oriented portion of the second track; a snow removal blade configured to be attached via attachment members to the first and second transmission means and configured to be able to travel along the length and downward oriented portion of the first and second tracks.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a side perspective view of a snow removal system;

FIG. 2 is a front view of the front end of a trailer with the snow removal system;

FIG. 3 is a side view of the trailer with the snow removal blade generally on the top of the trailer;

FIG. 4 is a front view of the top of a trailer with the snow removal system attached;

FIG. 5 is a perspective view of another embodiment of the snow removal system;

FIG. 6 is a detail view of the first blade drive shaft, first front sprocket, and first transmission means;

FIG. 7 is another detail view of the first blade drive shaft, first front sprocket, and first transmission means;

FIG. 8 is a close up view of the second track, second front sprocket, and second transmission means;

FIG. 9 is a perspective view of the first track and second track and their relationship to each other, with the motor-gearbox removed;

FIG. 10 is a close up view of the rear end of the second track;

FIG. 11 is a perspective view of the rear ends of the first and second tracks;

FIG. 12 is a perspective view of the inner side of the first track;

FIG. 13 is a side view of the second track with a snow removal blade attached to the second transmission means;

FIG. 14 shows the second track from FIG. 13 with the blade moved to the second blade holder member;

FIG. 15 shows the second track from FIG. 13 with the blade at the rear end of the track 22; and

FIG. 16 is a side view of a track.

### DETAILED DESCRIPTION

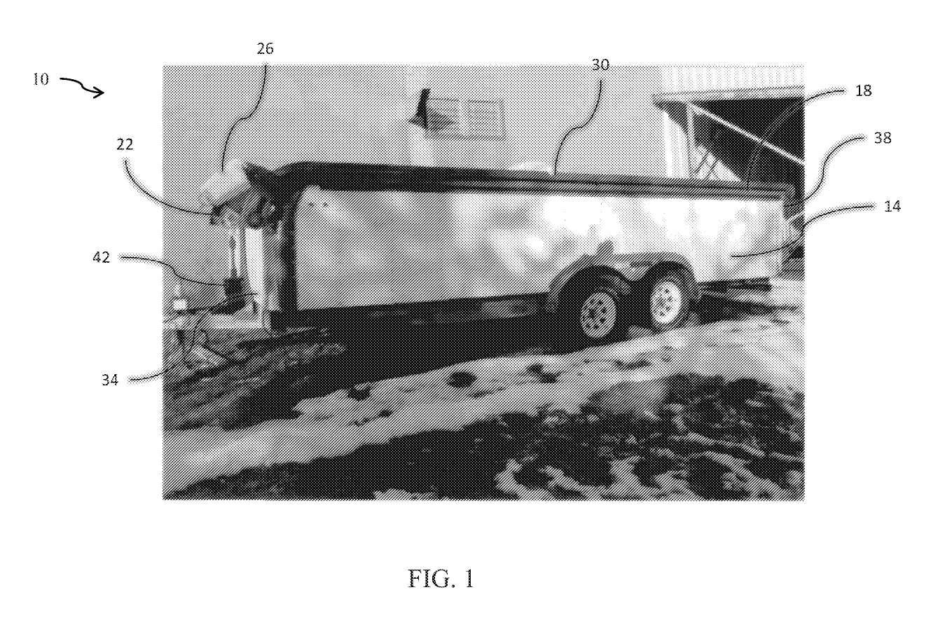

FIG. 1 shows a side perspective view of the snow removal system 10. A trailer 14 is shown, however, the disclosed system can be configured to work on any vehicle with a generally a large flat roof. A first track 18 is shown on one side of the trailer 14. A second track 22 is on the other side of the trailer 14. A snow removal blade 26 is attached to the two tracks 18, 22. One important feature is that the tracks 18, 22 in one embodiment are generally no higher than the top 30 of the trailer. In another embodiment, the tracks 18, 22 are 1″ or less above the top 30 of the trailer 14. In addition, when the snow removal system 10 is in a “home” position, the blade 26 is also generally no higher than the top 30 of the trailer. This is because the tracks 18, 22 are attached to the sides of the trailer 14, and the tracks 18, 22 curve down on one end of the trailer (either the front end 34 as shown, or the rear end 38 in other embodiments). In this embodiment, a motor 42 is located at the front end 34 of the trailer.

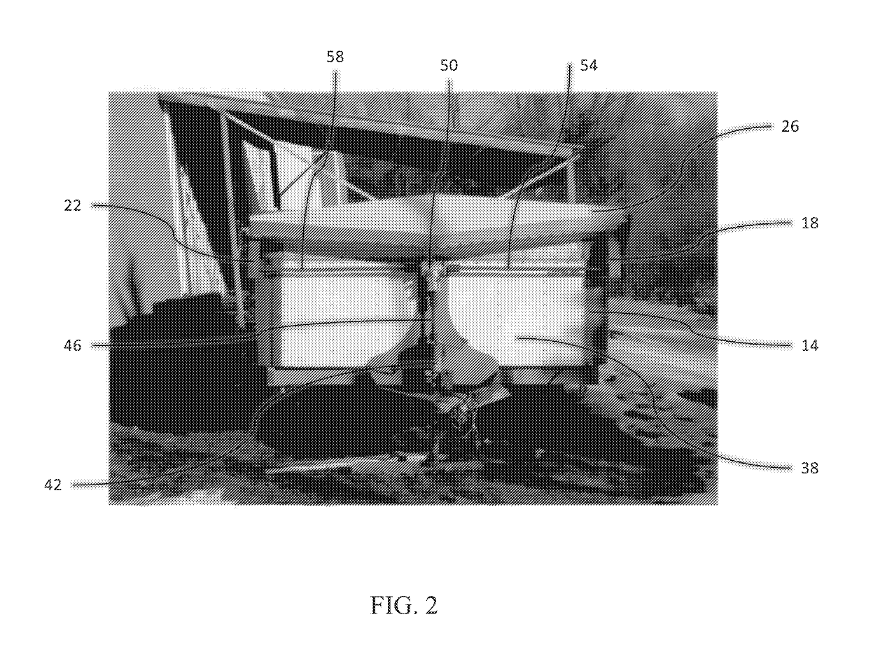

FIG. 2 shows a front view of the front end 38 of the trailer 14. Extending from the motor 42 is a first drive shaft 46. The drive shaft 46 enters a gear box 50. A first blade drive shaft 54 and a second blade drive shaft 58 exits the gear box and extends to the respective tracks 18, 22. At the distal end of the first blade drive shaft 54 is a first gear. At the distal end of the second blade drive shaft 58 is a second gear. The first track 18 encloses a first chain loop on pulleys. The second track 22 encloses a second chain loop on pulleys. The first gear is attached to the first chain loop, and the second gear is attached to the second chain loop. The snow removal blade is attached to a point on the first chain loop and second chain loop. Depending on the direction that the motor runs, the chain loops will move the snow removal blade 26 along the top 30 of the trailer 14, removing snow, ice and any other debris from the top 30 of the trailer 14. The motor 42 may be in electrical communication with a controller located in the cab of the truck that hauls the trailer. The driver can simply press an “on/off” button in the cab, that causes the snow removal blade to move from a home position to a snow a removing mode, where the blade 26 moves up from the home position and travels up the tracks 18, 22 that curve down the front of the trailer, and then along the top of the trailer, removing snow, ice, and other debris from the top of the trailer. The snow removal blade 26 then returns to the home position at the front of the trailer, and stored such that the snow removal blade 26 is below the top of the trailer. Of course, other operational modes may be programed into the controller. In another embodiment, the snow removal blade 26 may make two (or more) snow removing passes over the top of the trailer. In another embodiment, the operator may control the location of the blade 26 at any point along the tracks 18, 22.

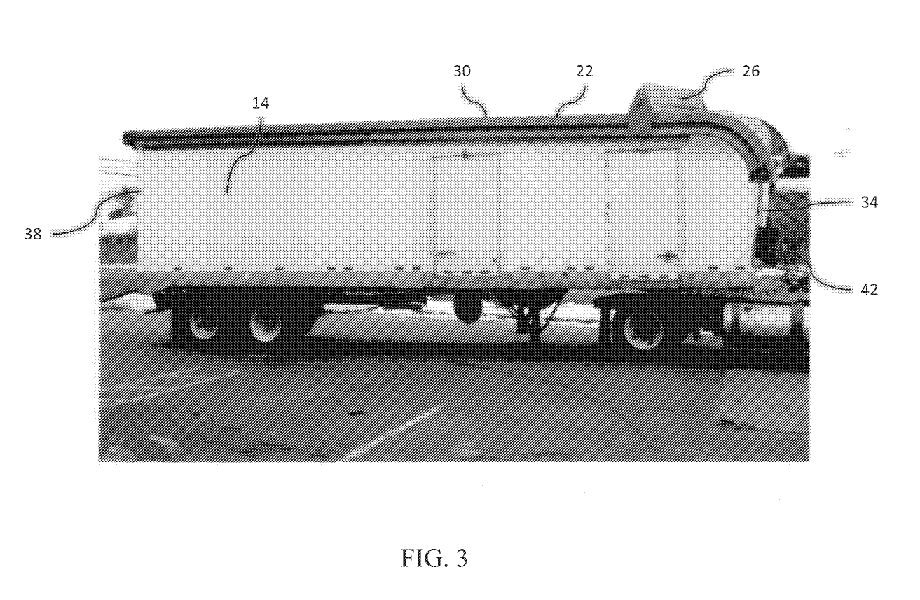

FIG. 3 shows a side view of the trailer with the snow removal blade 26 generally on the top 30 of the trailer 14.

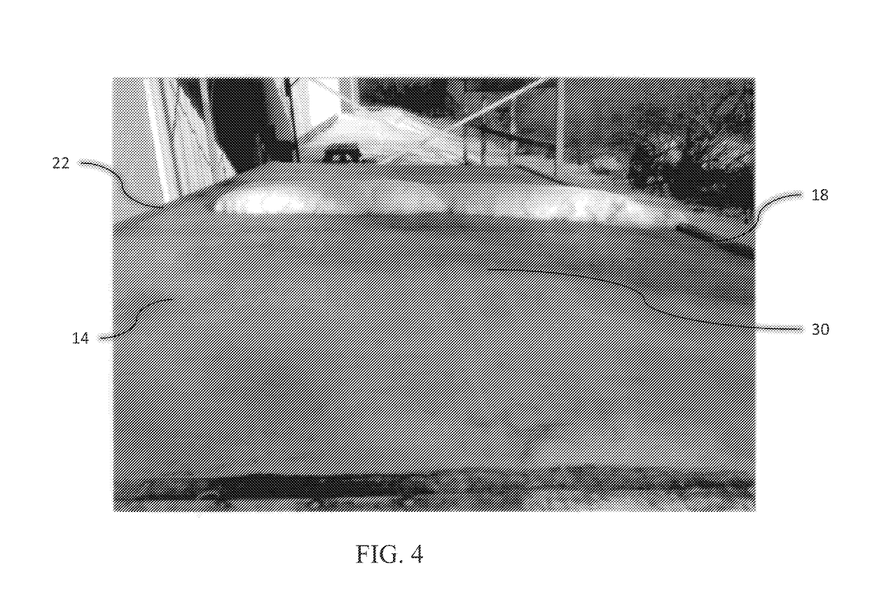

FIG. 4 shows the top 30 of a trailer 14 with the snow removal system 10 attached. One can see that the tracks 18, 22 do not extend higher than the top 30 of the trailer.

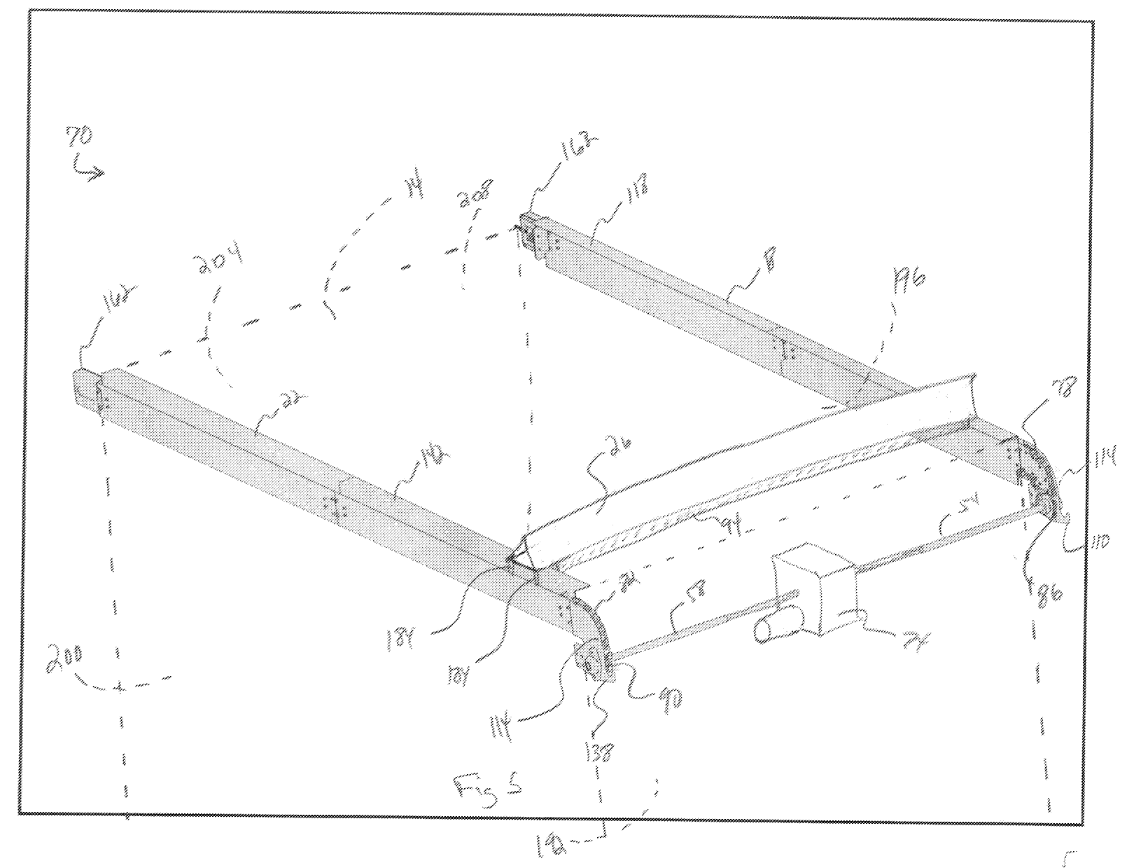

FIG. 5 shows another embodiment of the snow removal system 70. A vehicle 14, such as a trailer, is shown in dashed lines. In this embodiment, the gearbox and motor are combined in one unit, the motor-gearbox 74. In this view, a first transmission means 78, and second transmission means 82 are visible in the tracks 18, 22. The transmission means may be any suitable transmission, including but not limited to chains and belts. FIG. 5 shows chains as the transmission means 78, 82. The snow removable blade 26 is attached to the first and second transmission means 78, 82. The tracks 18, 22, also each comprise a front sprocket 86, 90, respectively. The tracks 18, 22 also each comprise a rear sprocket, not visible in this view. In one embodiment, the snow removal blade 26 comprises a blade with a curved triangular cross-sectional shape, where the legs of the triangle are curved inward, and the base of the triangle is generally not curved. This blade shape is effect for snow removal from the top of a trailer, or other vehicle, in both directions, that is when the blade i26 is traveling towards the rear of the vehicle, or when traveling towards the front of the vehicle. The snow removal blade 26 may also comprise a front sweep 94, and a rear sweep 98 (not visible in this view). The sweeps 94, 98 may comprise any suitable material, including but not limited to urethane. The front ends 114 and rear ends 162 of the tracks are shown. In this embodiment, the front ends 114 of the tracks 18, 22 extend downwardly along the front of the vehicle or trailer. Such that when the blade 26 is stored in the first blade holder member 110 and second blade holder member 138, the blade 26 will be below the top surface of the vehicle or trailer. The snow removal blade 26 may be attached to the first and second transmission means 78, 82 via attachment members 184. The first track 18 may comprise a top lip 118 that is configured to generally sit on top of the trailer 14. The second track 22 may comprise a top lip 142 that is configured to generally sit on top of the trailer 14. The trailer may comprise a front side 192, right side 196, left side 200, rear side 204 and top side 208.

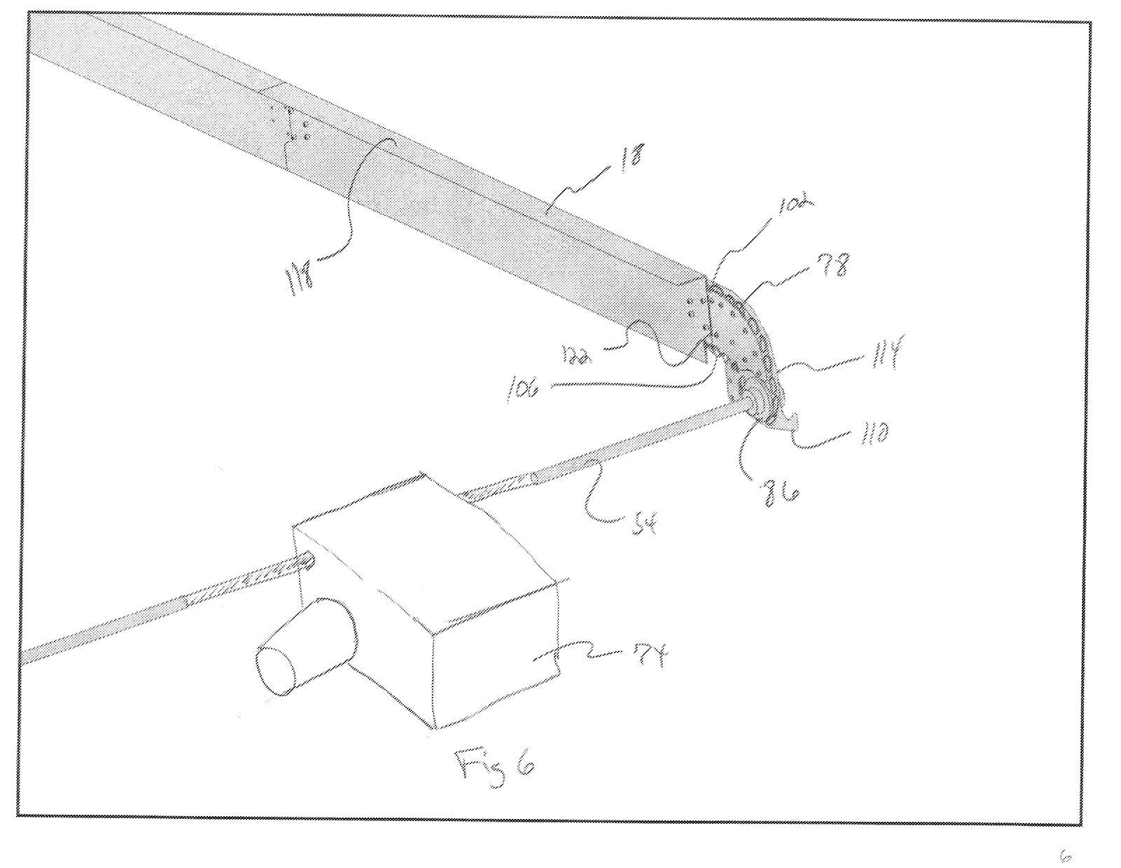

FIG. 6 shows a detail view of the first blade drive shaft 54, first front sprocket 86, and first transmission means 78, in this embodiment a chain. The first transmission means 78 may be a chain loop that is exposed on the top side 102 of the loop, thus allowing for the snow removable blade 26 to be attached to the top side of the chain loop. The bottom side 106 of the loop may be inside the first track 18. The first track 18 may have a first blade holder member 110 located at the front end 114 of the track 18. The second track 22 may have generally a mirror image configuration to the first track 18. The first track 18 may comprise a top lip 118 that is configured to generally sit on top of the trailer 14. The first track 18 may also comprise a conduit 122 for the lower side 106 of the loop.

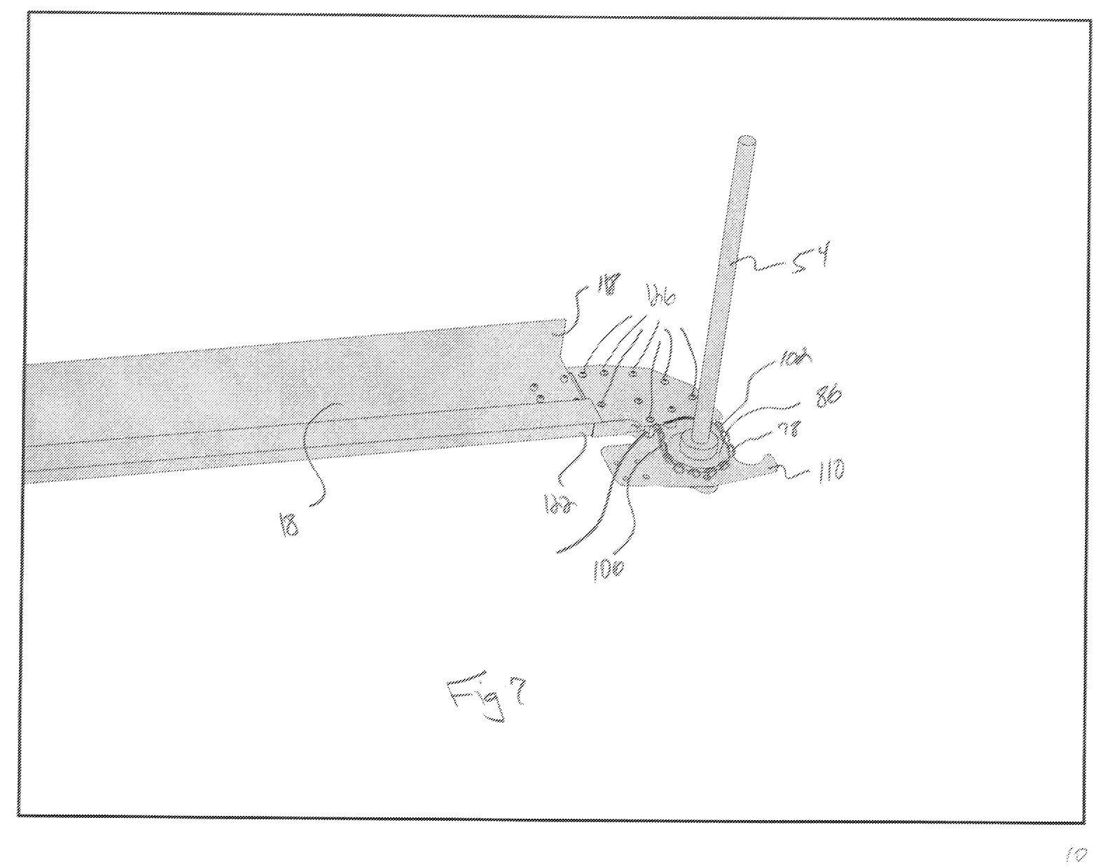

FIG. 7 is another detail view of the first blade drive shaft 54, first front sprocket 86, and first transmission means 78. In this view, the chain guide members 126 are more visible, and are shown guiding the chain 78 into the conduit 122 and into upper portion of the track 18. The chain guide members 126 may be simple cylindrical guide members that guide the chain into the proper position, may be bearings that guide the chain into the proper position, or may be an attachment means that attaches to a rail that guides the chain into the proper position.

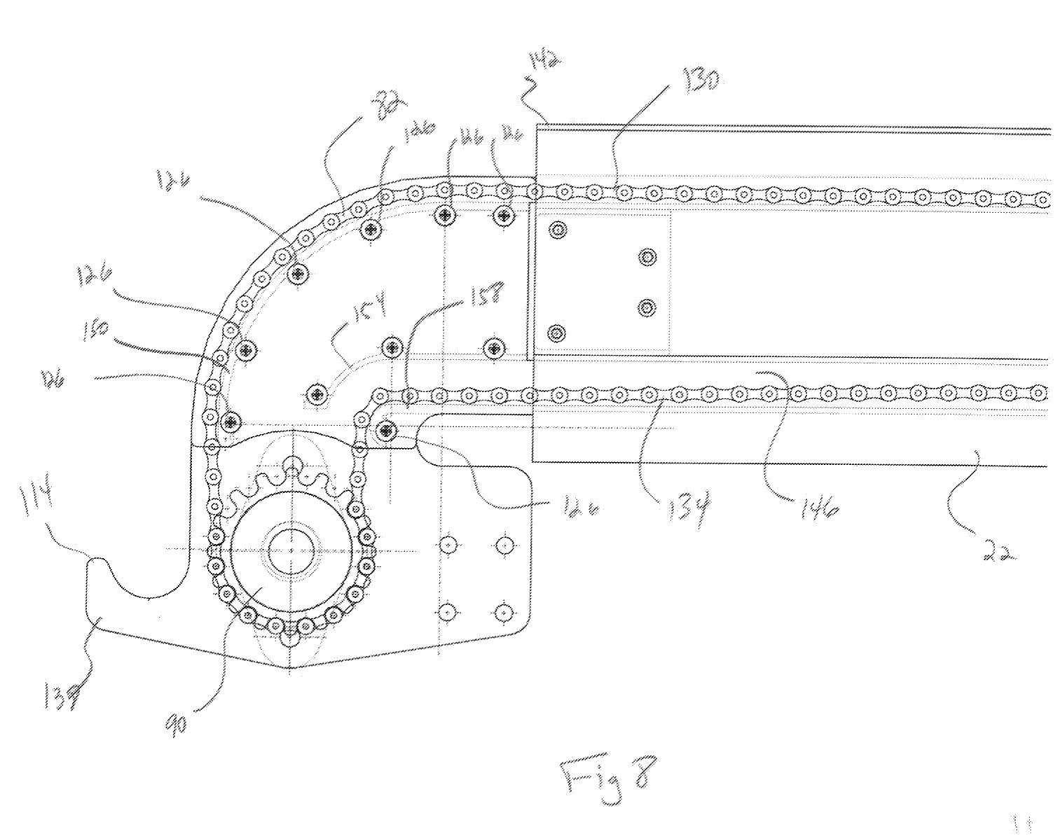

FIG. 8 is a close up view of the second track 22, second front sprocket 90, and second transmission means 82. In this embodiment, the transmission means 82 may be a chain. The chain 82 forms a loop with a top side 130 and a bottom side 134. The second track has a second blade holder member 138 located at the front end 114 of the track 22. The second track 22 comprises a top lip 142 that is configured to generally sit on top of the trailer 14. The second track 22 may also comprise a conduit 146 for the lower side 106 of the loop. In this embodiment chain guide members 126 are attached to an upper rail 150, a first lower rail 154, and a second lower rail 158 to guide the chain 82.

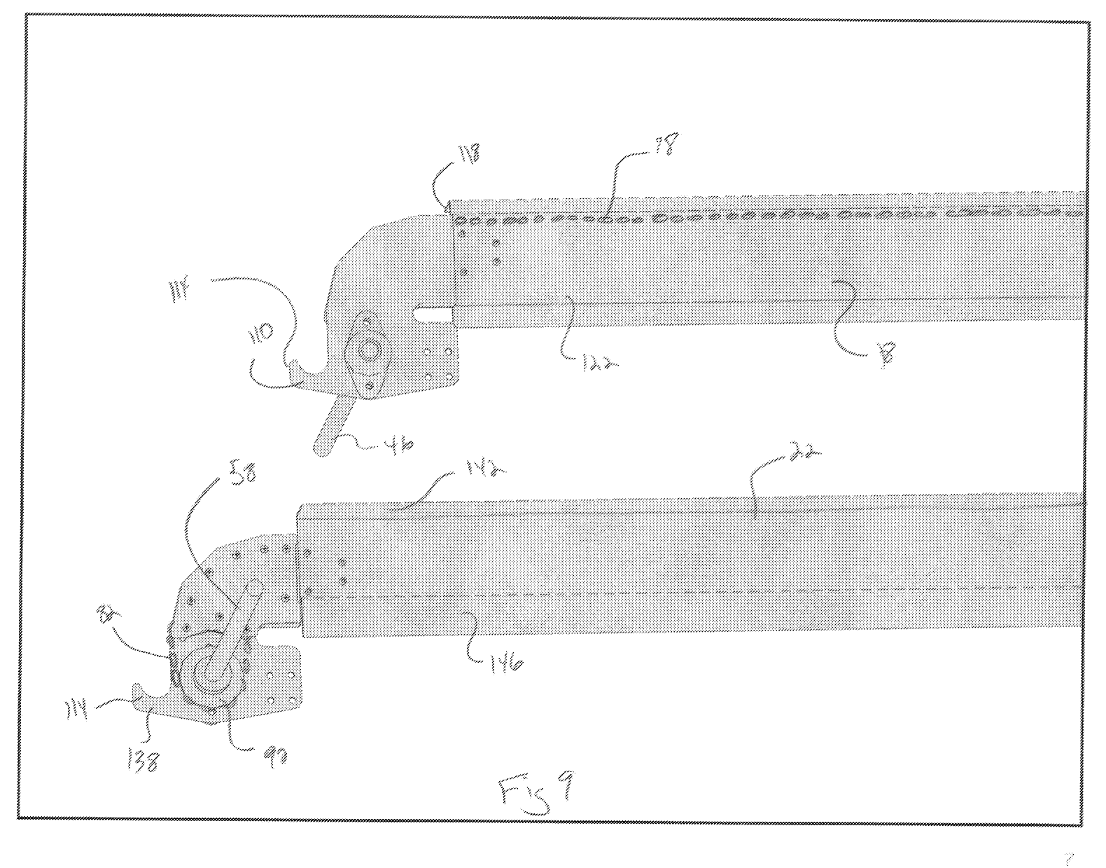

FIG. 9 is a perspective view of the first track 18 and second track 22 and their relationship to each other, with the motor-gearbox 74 removed.

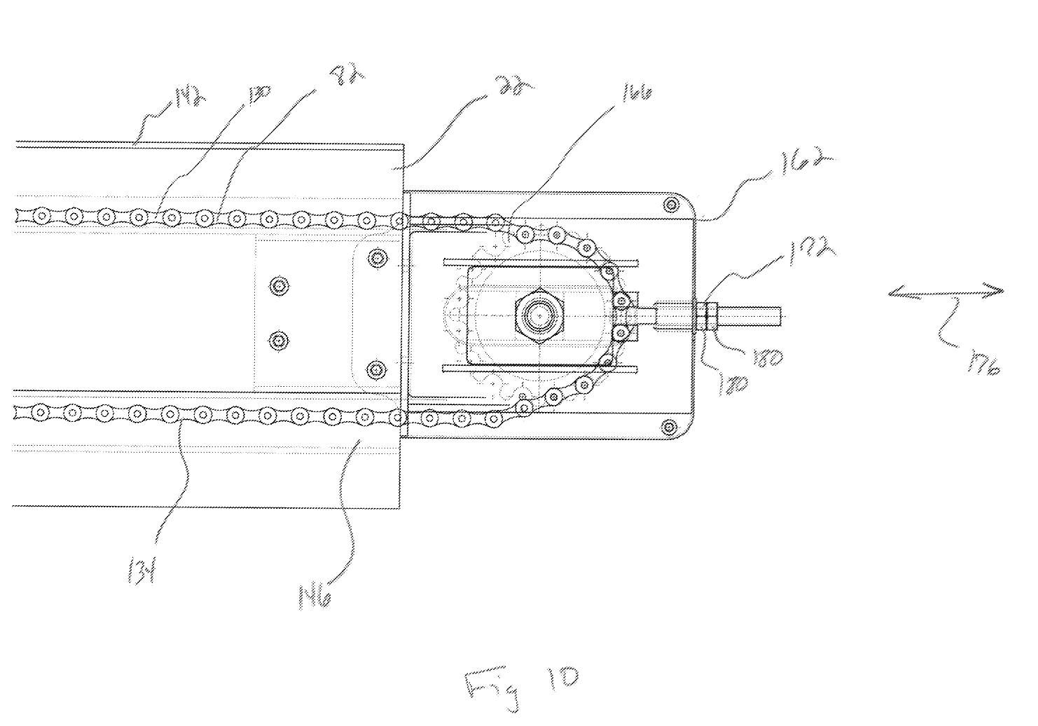

FIG. 10 is a close up view of the rear end 162 of the second track 22. In this view the second track rear sprocket 166 is shown. The rear sprocket is attached to the rear end 162 of the second track 22. The rear sprocket 166 is slideably adjustable using the chain tensioner 172. The chain tensioner 172 allows a user to move the sprocket in the directions of the arrow 176 in order to tighten or loosen the chain 82 as needed. The chain tensioner 172 may comprise jam nuts 180 to lock the tensioner 172 in place. The First track 18 will also have a rear sprocket, and chain tensioner.

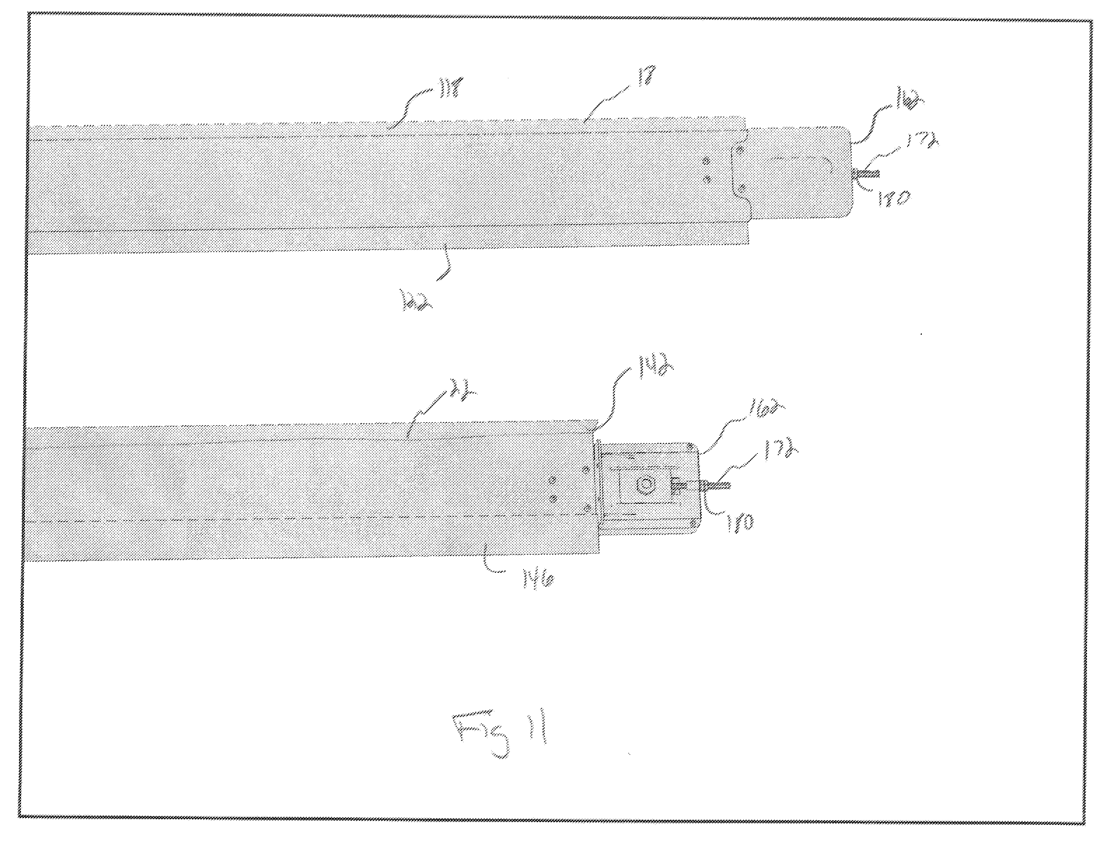

FIG. 11 is a perspective view of the rear ends 162 of the first and second tracks 18, 22.

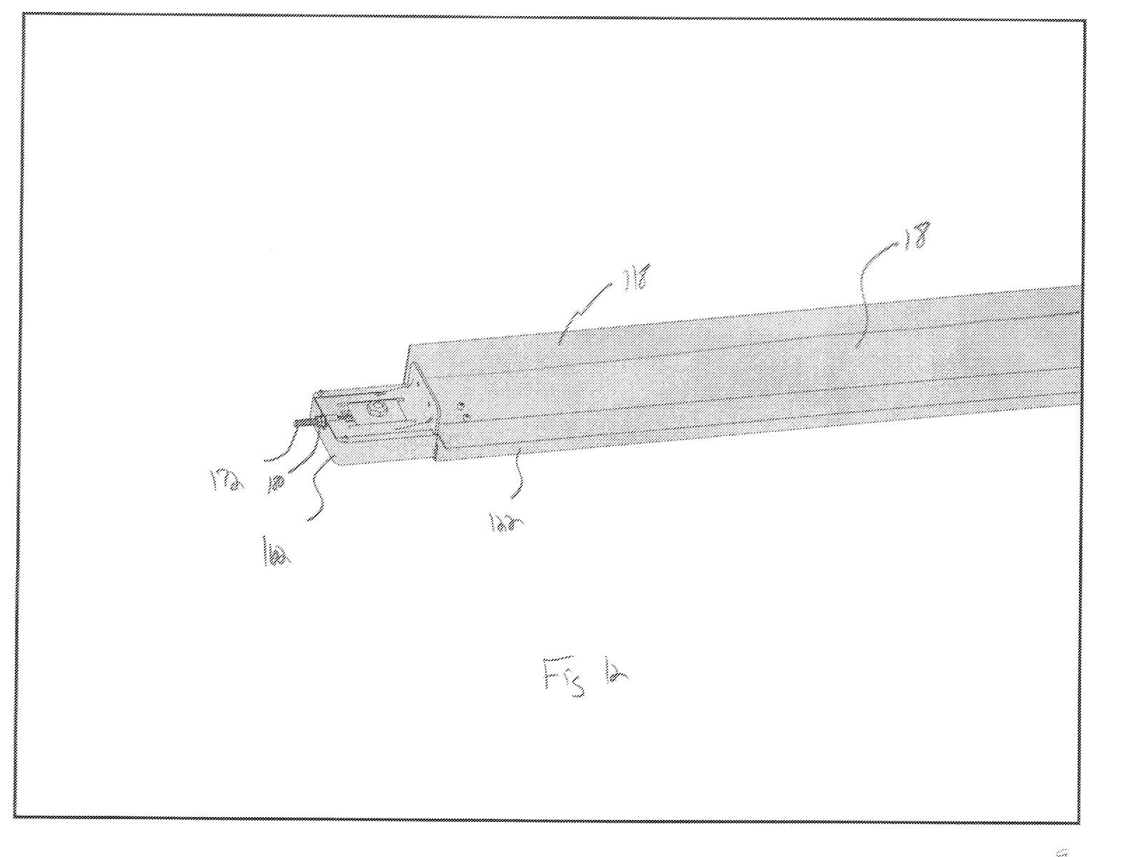

FIG. 12 is a perspective view of the inner side of the first track 18.

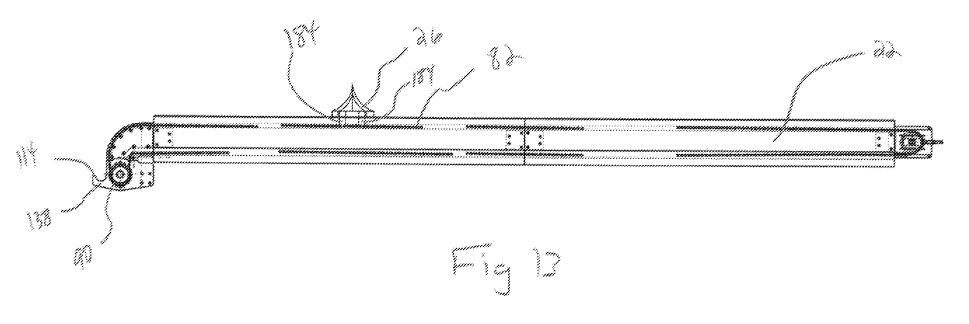

FIG. 13 is a side view of the second track 22 with a snow removal blade 26 attached to the second transmission means 82. The snow removal blade 26 attaches to the transmission means via attachment members 184. In this view the snow removal blade 26 is shown along the top of the second track 22. The blade 26 is configured to travel up and down the first and second tracks 18, 22 via the transmission means 78, 82.

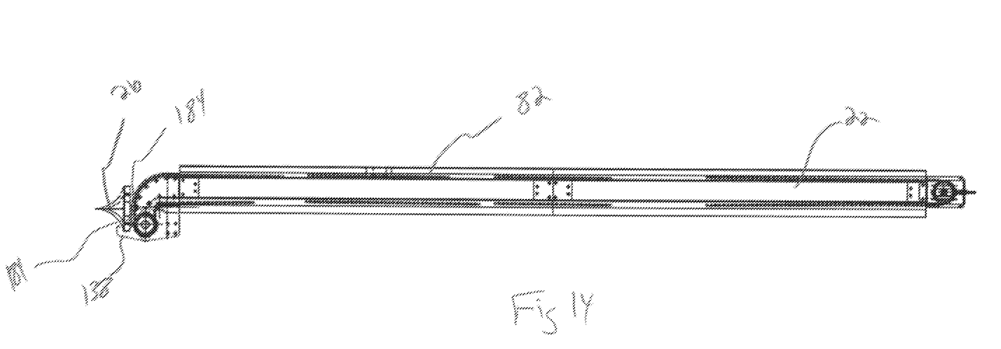

FIG. 14 shows the second track 22 from FIG. 13, however in this view; the blade 26 is moved to the second blade holder member 138. In this position, the vehicle with the snow removal system 10, 70 installed, can travel, with the snow removal blade 6 out of the way, and not causing an excessive amount of air friction.

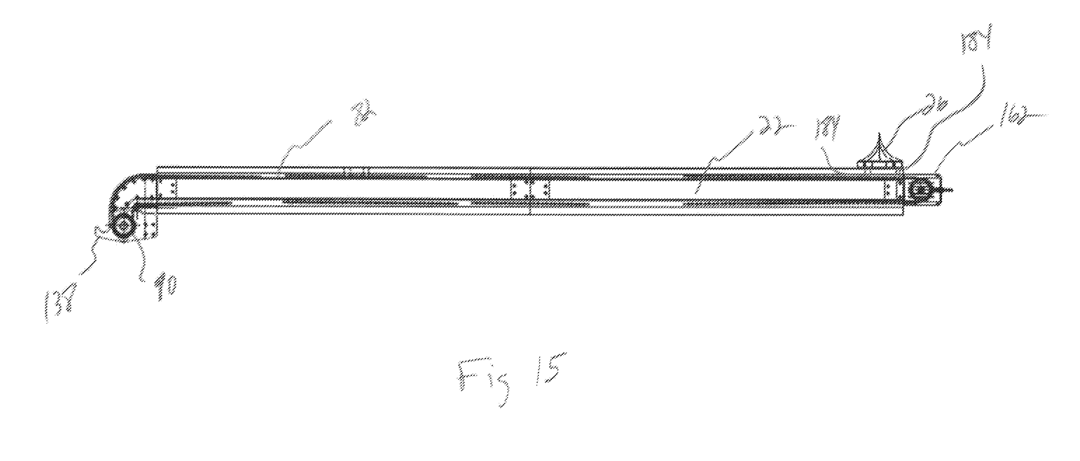

FIG. 15 shows the second track from FIG. 13, but in this view, the blade 26 is shown at the rear end 162 of the track 22. Thus, the blade 26 can travel along the track from any position shown in FIG. 13-15, and any point in between.

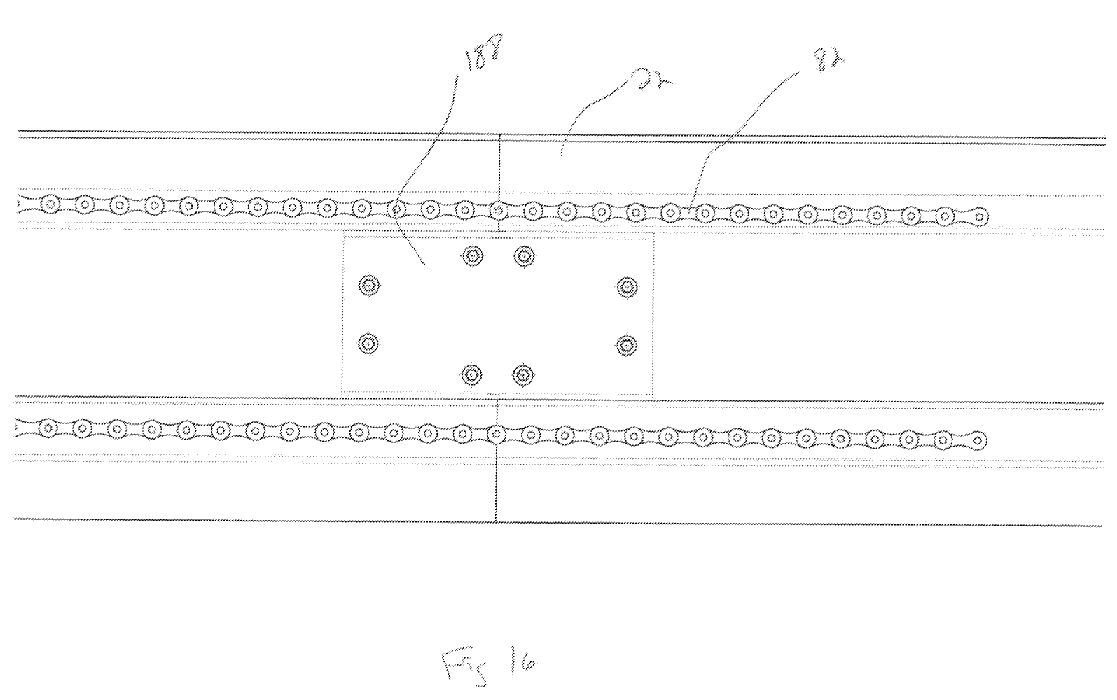

FIG. 16 shows how the tracks may comprise two or more pieces. FIG. 16 shows the second track 22 and the second transmission means 82. The tracks can be configured to fit on different sized vehicles by connecting various lengths of tracks via a track connector 188. The track connector 88 may be a means to attach to adjacent pieces of track. In one embodiment, the track connector may be a metal bar attached to two adjacent pieces of track via machine screws.

The disclosed system may be made out of lightweight materials such as aluminum, so that the snow removal system (excluding the trailer) may weigh no more than 658 pounds on an 18 foot trailer, or 1140 pounds on a 52 foot trailer.

This invention has many advantages. It provides for snow removal on large vehicles, such as trailers. The invention attaches to a trailer, in one embodiment, so that the snow removal system is always available to the user. The invention has a low profile that is it does not stick up past 1″ above the surface of the vehicle/trailer that is being removed of snow. The invention has a low side profile, in that it does not stick out past 1.875 inches from the side of the vehicle/trailer. Because the invention is attached to the trailer/vehicle, users will generally use the snow removal invention more often, thus making the roadways safe from sheets of snow and ice flying up off of vehicles and trailers thus reducing damage, injury, and even death. Further, the snow removal invention does not require a user to climb to the top of trailer or vehicle in order to remove snow, thus preventing from possibly falling off vehicles and trailers, especially in icy, windy, rainy, and/or snowy conditions.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A low profile snow removal system comprising:
a first track;
a second track located generally parallel to the first track housing;
a snow removal blade in slidable communication with the first track and the second track;
a driving means in operable communication with the snow removal blade and configured to move the snow removal blade along the length of the first and second tracks.

2. The low profile snow removal system of claim 1 further comprising:
a trailer with a top side, front side, right side, left side, and rear side, and where the first track is attached to the right side, the second track is attached to the left side; and driving means is attached to the front side.

3. The low profile snow removal system of claim 2, where the snow removal system does not extend past 1 inch above the top side of the trailer, excluding any snow and/or ice.

4. The low profile snow removal system of claim 2, where the snow removal system does not extend past 1.875 inches beyond the right side or left side of the trailer.

5. The low profile snow removal system of claim 1 further comprising:
a front sweep extending downwardly from the front side of the snow removal blade;
a rear sweep extending downwardly from the rear side of the snow removal blade.

6. The low profile snow removal system of claim 1, wherein the front sweep and rear sweep are generally made out of urethane.

7. The low profile snow removal system of claim 26, where the motor-gearbox has a 3 to 1 gear ratio.

8. The low profile snow removal system of claim 1, where the system weighs less than about 658 pounds when used on a trailer that is about 18 feet long.

9. The low profile snow removal system of claim 1, where the system weighs less than about 1140 pounds when used on a trailer that is about 52 feet long.

10. The low profile snow removal system of claim 1, further comprising:
a first track top lip that extends generally orthogonally from the first track and is configured to rest on top of the surface that is to be generally removed of snow;
a second track top lip that extends generally orthogonally from the second track and is configured to rest on top of the surface that is to be generally removed of snow.

11. The low profile snow removal system of claim 27, wherein the first rear sprocket is adjustably slideable within the first track via a first transmission means tensioner in operable communication with the first rear sprocket; and wherein the second rear sprocket is adjustably slideable within the second track via a second transmission means tensioner in operable communication with the second rear sprocket.

12. The low profile snow removal system of claim 1, wherein the cross-sectional shape of the snow removal blade is triangular, where the legs of the triangle are curved inward, and the base of the triangle is generally not curved.

13. A low profile snow removal apparatus comprising:
a first track;
a second track located generally parallel to the first track housing;
a snow removal blade in slidable communication with the first track and the second track;
a driving means in operable communication with the snow removal blade and configured to move the snow removal blade along the length of the first and second tracks.

14. The low profile snow removal apparatus of claim 13, where the snow removal apparatus is configured to not extend past 1 inch above the surface to be generally removed of snow.

15. The low profile snow removal apparatus of claim 13, where the snow removal apparatus does not extend past 1.875 inches beyond the right side or left side of the vehicle it is attached to.

16. The low profile snow removal apparatus of claim 13 further comprising:
a front sweep extending downwardly from the front side of the snow removal blade;
a rear sweep extending downwardly from the rear side of the snow removal blade.

17. The low profile snow removal apparatus of claim 13, wherein the front sweep and rear sweep are generally made out of urethane.

18. The low profile snow removal apparatus of claim 24, where the motor-gearbox has a 3 to 1 gear ratio.

19. The low profile snow removal apparatus of claim 13, where the system weighs less than about 658 pounds when used on a trailer that is about 18 feet long.

20. The low profile snow removal apparatus of claim 13, where the system weighs less than about 1140 pounds when used on a trailer that is about 52 feet long.

21. The low profile snow removal apparatus of claim 13, further comprising:
a first track top lip that extends generally orthogonally from the first track and is configured to rest on top of the surface that is to be generally removed of snow;
a second track top lip that extends generally orthogonally from the second track and is configured to rest on top of the surface that is to be generally removed of snow.

22. The low profile snow removal apparatus of claim 25, wherein the first rear sprocket is adjustably slideable within the first track via a first transmission means tensioner configured to be in operable communication with the first rear sprocket; and wherein the second rear sprocket is adjustably slideable within the second track via a second transmission means tensioner configured to be in operable communication with the second rear sprocket.

23. The low profile snow removal system of claim 13, wherein the cross-sectional shape of the snow removal blade is triangular, where the legs of the triangle are curved inward, and the base of the triangle is generally not curved.

24. The low profile snow removal apparatus of claim 15, wherein the driving means comprises:
a motor-gearbox.

25. The low profile snow removal apparatus of claim 16, wherein the driving means further comprises:
a drive shaft in operational communication with the motor-gearbox;
a first front sprocket in fixed communication with the blade drive shaft and housed in the first track at the front end of the first track;
a first rear sprocket located in the first track on the rear end of the track;
a first transmission means in rotatable communication with the first front sprocket and the first rear sprocket, and configured to generally rotate in either direction along the length and downward oriented portion of the first track;
a second front sprocket in fixed communication with the blade drive shaft and housed in the second track at the front end of the second track;
a second rear sprocket located in the second track on the rear end of the track;
a second transmission means in rotatable communication with the second front sprocket and the second rear sprocket, and configured to generally rotate in either direction along the length and downward oriented portion of the second track;
wherein the snow removal blade is attached via attachment members to the first and second transmission means and configured to be able to travel along the length of the first and second tracks.

26. The low profile snow removal system of claim 1, wherein the driving means comprises:
a motor-gearbox.

27. The low profile snow removal system of claim 3, wherein the driving means further comprises:
a drive shaft in operational communication with the motor-gearbox;
a first front sprocket in fixed communication with the blade drive shaft and housed in the first track at the front end of the first track;
a first rear sprocket located in the first track on the rear end of the track;
a first transmission means in rotatable communication with the first front sprocket and the first rear sprocket, and configured to generally rotate in either direction along the length and downward oriented portion of the first track;
a second front sprocket in fixed communication with the blade drive shaft and housed in the second track at the front end of the second track;
a second rear sprocket located in the second track on the rear end of the track;
a second transmission means in rotatable communication with the second front sprocket and the second rear sprocket, and configured to generally rotate in either direction along the length and downward oriented portion of the second track;
wherein the snow removal blade is attached via attachment members to the first and second transmission means and configured to be able to travel along the length of the first and second tracks.
